(19) United States
(12) Patent Application Publication
(10) Pub. No.: US 2006/0233542 A1
(43) Pub. Date: Oct. 19, 2006

(54) Digital data presenting apparatus

(75) Inventor: Jim Chen, Zhubei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Lumens Digital Optics Inc., Jhubei City (TW)

(21) Appl. No.: 11/328,649

(22) Filed: Jan. 10, 2006

(30) Foreign Application Priority Data
Apr. 19, 2005 (TW) 094112464

(51) Int. Cl. G03B 15/03

(52) U.S. Cl. 396/155

(57) ABSTRACT

A digital data presenting apparatus having a lighting system and a camera system is provided. The lighting system is used to emitting a light and further includes a lens assembly for controlling the light to the projection area of an object. The camera system further includes an image-sensing component, a camera lens positioned on one side of the image-sensing component and a first deflector adjusting a propagation direction of the light reflected from the object to be displayed to the image-sensing component through the camera lens.

### FIELD OF THE INVENTION

The invention relates to a digital data presenting apparatus, and more particularly to a digital data presenting apparatus with an improved projection light efficiency.

### BACKGROUND OF THE INVENTION

The so-called digital data presenting apparatus is an apparatus grabbing the images of an object displayed through a camera system and projecting the images on display screen. The operation concept of the digital data presenting apparatus is that the displayed image of an object is grabbed by charge coupled device (CCD) or complementary metal oxide semiconductor (CMOS) camera when the said object is under the illumination of a light source and further converted by a ADC (Analog to Digital Converter) chip so that the original image signal (analog signal) is converted into an electronic signal (digital signal) which is input to a projector and displayed on screen thereby. The object to be displayed may be a 3D object, a moving object, a transparency, a film or a slide. The display may be an LCD display, a plasma TV, and an LED array or a projector. The conventional digital data presenting apparatus includes a camera system and an object-loading platform, which utilize the light in the ambient as its light source. Whereas, when using the ambient light as the light source of the digital data presenting apparatus, the brightness of the projecting light is uncontrollable.

To improve the brightness of the projecting light, a conventional enhanced digital data presenting apparatus is developed, in which the lighting system is integrated along with the camera system as shown in FIG. 1. The digital data presenting apparatus 11 positioned on the ceiling 17 contains a lighting system 13 and a camera system 12, in which the lighting system 13 is used to illuminate an object to be displayed 15 and the camera system 12 is used to grab the image of the object to be displayed 15. The grabbed image is displayed by means of a projector 14. The lighting system 13 is an incandescent bulb or a halogen bulb having a reflector, in which the halogen bulb having the reflector provides better projection quality, significantly improving the projection light brightness. However, the problem of the uneven brightness still exists in such a digital data presenting apparatus. As the resulting projecting light still diverges, the projection area of the light becomes uneven.

For sake of making the displayed image demonstrated by the digital data presenting apparatus more clear and vivid, the brightness of the projecting light, the uniformity of the projecting light and the projection range of the projecting light onto the object to be displayed are all critical criteria to be taken into account. As such, how to apply a simple and convenient means to enhance the projection brightness, uniformity and projection range of the lighting system in the digital data presenting apparatus becomes a very crucial subject.

For overcoming the drawbacks of the conventional digital data presenting apparatus, the present invention provides a novel digital data presenting apparatus which has an improved projection efficiency.

### SUMMARY OF THE INVENTION

In accordance with a first aspect of the present invention, a digital data presenting apparatus is provided and which is used to be mounted on the ceiling. The provided digital data presenting apparatus includes a lighting system emitting a light and having a lens assembly controlling the light onto a projection area of an object, a camera system having an image-sensing component, a camera lens positioned on one side of the image-sensing component, and a first deflector adjusting a propagation direction of the light reflected from the object to be displayed to the image-sensing component through the camera lens.

Preferably, the digital data presenting apparatus is a digital data visualizer.

Preferably, the image-sensing component is one of a charge coupled device (CCD) and a complementary metal oxide semiconductor (CMOS) image sensor.

Preferably, the lens assembly has an adjustable focal distance.

Preferably, the first deflector is a reflector controlling a reflection angle of the light by means of an adjustment device for altering a reflection direction of the light.

Preferably, the lighting system further includes a light-emitting component emitting a light, a light tunnel component collecting the light emitted from the light-emitting component, a frame determining a shape of the projection area of the light guided to the lens assembly, and a second deflector guiding the light to the object to be displayed.

Preferably, the light-emitting component is a halogen bulb.

Preferably, the halogen bulb has a reflector.

Preferably, the second deflector is a reflector controlling a reflection angle of the light by means of an adjustment device for altering a reflection direction of the light.

Preferably, the adjustment device is a screw.

In accordance with the second aspect of the present invention, a digital data presenting apparatus is provided, the digital data presenting apparatus includes a lighting system having a light-emitting component providing a light, a lens assembly controlling the light to a projection area of an object to be displayed, a frame determining a shape of a projection area of the light guided to the lens assembly, a deflector for guiding the light to the object, and a camera system having an image-sensing component, a camera lens positioned on one side of the image-sensing component and a second deflector for adjusting a propagation direction of the light reflected from the object to the image-sensing component through the camera lens.

Preferably, the image-sensing component is one of a charged coupled device (CCD) or a CMOS image sensor.

Preferably, the first and second deflectors are reflectors controlling a reflection angle of the light by means of an adjustment device for altering a reflection direction of the light.

Preferably, the lens assembly has an adjustable focal distance.

Preferably, the light-emitting component is a halogen bulb.

Preferably, the halogen bulb has a reflector.

The foregoing and other features and advantages of the present invention will be more clearly understood through the following descriptions with reference to the drawing, wherein:

### BRIEF DESCRIPTION OF THE DRAWINGS

FIG. 1 is a schematic diagram showing components dispensed in a conventional enhanced digital data presenting apparatus; and

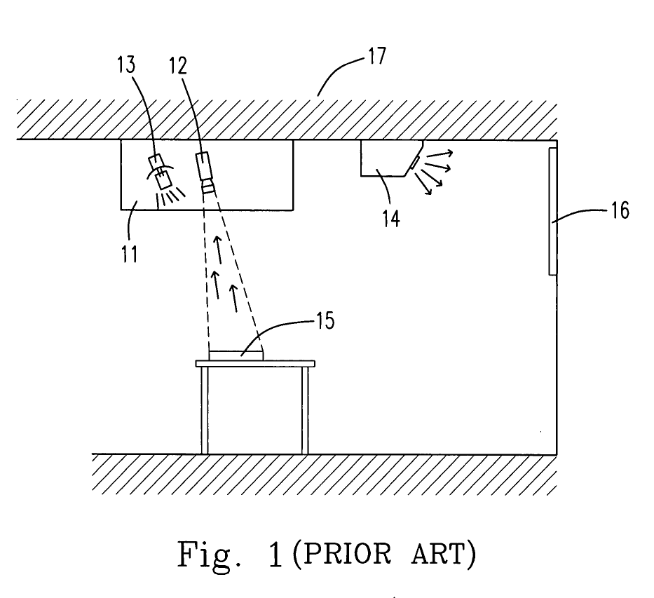

FIG. 2 is a schematic diagram showing components dispensed in a digital data presenting apparatus according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

To overcome the insufficient and uneven brightness problem of the projecting light in the conventional digital data presenting apparatus, the present invention provides a digital data presenting apparatus for solving the mentioned issue and enhancing the projection quality for the object to be displayed accordingly.

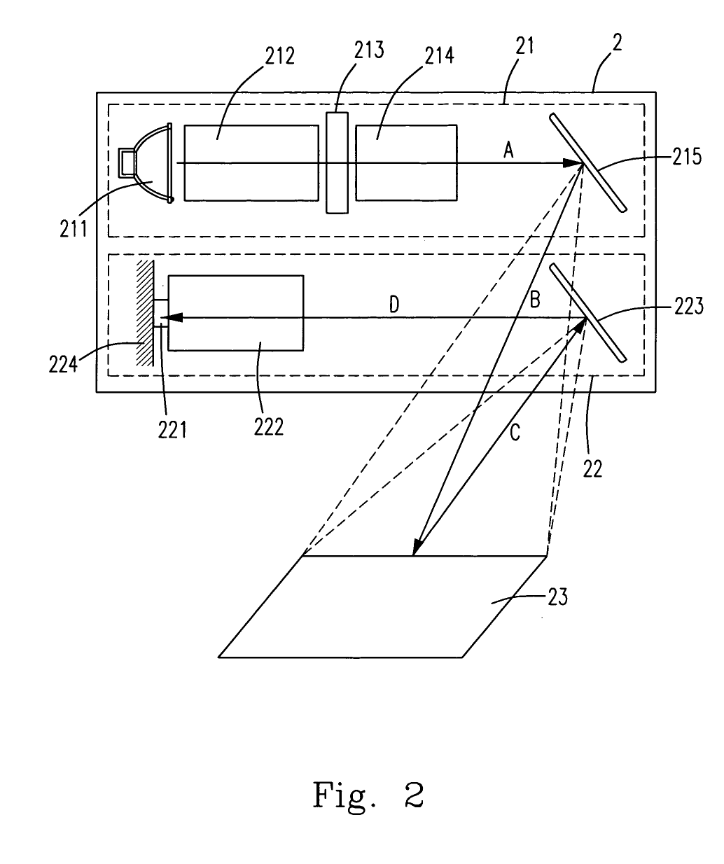

Please refer to FIG. 2 showing the components dispensed in a digital data presenting apparatus 2 of a preferred embodiment of the present invention. The digital data presenting apparatus 2 in the present invention is actually a visualizer. The digital data presenting apparatus 2 includes a lighting system 21 and a camera system 22, in which the lighting system 21 functions to provide a projection light to an object to be displayed 23 so that the projecting light is reflected by the object to be displayed 23. Meanwhile, the projecting light is sensed by the camera system 22 so as to further present the image of the object to be displayed 23 on a screen (not shown in FIG. 2). The lighting system 21 further includes a light-emitting component 211, a light tunnel component 212, a frame 213, a lens assembly 214 and a first deflector 215, wherein the light-emitting component 211 is used to emit a projecting light and the projecting light in the lighting system propagates along the direction indicated by the arrow A. The projecting light emitted from the light-emitting component 211 is collected to enter the frame 213 so as to fall in a projection range of the projecting light and adjust the shape of the projection area thereof associated with the lens assembly 214 by virtue of the range and shape adjustment of the frame 213, whereby it allows the adjusted projecting light to further enter the lens assembly 214. As for the projection area size of the projecting light to the object to be displayed 23, depending on the position of the object to be displayed 23, the optimized projection distance and area are available by the adjustment of the focal distance of the lens assembly 214. As the digital data presenting apparatus 2 is dispensed on the ceiling and the direction of the projecting light needs to be directed to the position of the object to be displayed 23 during operation, the second deflector 215 is used to direct the propagation of the projecting light to the direction toward the object to be displayed 23, i.e. the direction indicated by the arrow B in FIG. 2.

The light-emitting component 211 is a halogen bulb, preferably one with a reflector, and thereby the lights emitted from a regular light bulb are directed to a certain direction. In addition, the scattering lights are further concentrated by the reflector, so as to secure better brightness of the projecting light. As a consequence, the image quality of the object is improved. In other words, the halogen bulb with a reflector taken as the light-emitting component 21 is able to deliver better imaging quality to the digital data presenting apparatus 2 of the present invention.

The light tunnel component 212 is configured in the propagation direction of the projecting light of light-emitting component 211. In other words, the light tunnel component 212 directly receives the projecting light emitted from the light-emitting component 211 and confines the lights therein so as to further alleviate the edge scattering phenomenon of the projecting light emitted from the light-emitting component 211. Besides, the interior surface of the light tunnel component 212 is able to be treated for having a high reflection performance, such as the mirror polishing and the galvanization processing. Alternatively, the light tunnel is made of a metal sheet or even made of a material of glass so as to further confine the received light in a certain range and keep the light being reflected inside the channel of the light tunnel component 212. Accordingly, the drawback that the light brightness in central is different from that over the edge is overcome. In other words, the brightness evenness is increased.

The range of the projecting light collected by the tunnel component 212 and the shape of the projection area thereof are adjusted by means of the frame 213. The frame 213 is a mask, whose shape is a rectangle, circle, polygon or others. The frame is configured between the light tunnel 212 and the lens assembly 214, so as to further adjust the shape of the projection area.

The light with an adjusted shape of the projection area passes through the lens assembly 214. The focal distance of the lens assembly 214 is controllable and adjustable in accordance with the size and the position of the object to be displayed 23, and hence the projection area is also adjusted in conformity with the object to be displayed 23.

Accordingly, the brightness of the projecting light of the digital data presenting apparatus is concentrated, and the brightness uniformity thereof is also increased. Besides, the projection area onto the object to be displayed 23 is adjusted as well. However, because the digital data presenting apparatus 2 is dispensed on a ceiling, it is necessary to guide the adjusted light to the object to be displayed 23 with the first deflector 215. The first deflector 215 is a reflector, and as a result, the user can control the angle of the reflector via an adjustment device (e.g. an adjustment screw) so as to control the reflection angle of the light and guide the projecting light to the object to be displayed 23.

In addition, the camera system 22 also adapts itself to the lighting system 21 to bring about some different designs. As shown in FIG. 2, the camera system 22 contains an image-sensing component 221, a camera lens 222 and a second deflector 223. The image-sensing component 221 is a CCD or a CMOS image sensor and is dispensed on the base 224. The camera lens 222 is dispensed on one side of the image-sensing component 221. The second deflector 223 is used to adjust the propagation of the light along the direction indicated by the arrow C to that by the arrow D in FIG. 2 so as to make the light enter the camera lens 222 and be sensed by the image-sensing component 221.

In summary, the invention provides a digital data presenting apparatus having a lighting system and a camera system. By means of the novel configuration of the internal components of the digital data presenting apparatus, the projecting light is more concentrated, and the brightness and uniformity of the projecting light, the projection range and the shape of the projection area are sufficiently improved. Moreover, by means of the adjustment of focal distance of a lens assembly, the brightness and evenness of the projecting light is also adjustable in accordance with the position and the size of the object to be displayed, which enables to augment the utilization efficiency of light. Furthermore, the imaging quality of the digital data presenting apparatus is enhanced and the shortcoming regarding uneven brightness of projecting light of the digital data presenting apparatus is also overcome. In comparison with the conventional digital data presenting device, the digital data presenting device provided by the present invention has a more simplified configuration and an improved performance. Therefore, the present invention not only has a novelty and a progressive, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A digital data presenting apparatus, comprising:
a lighting system emitting a light and having a lens assembly controlling said light onto a projection area of an object; and
a camera system having an image-sensing component, comprising:
a camera lens positioned on one side of said image-sensing component; and
a first deflector adjusting a propagation direction of said light reflected from said object to be displayed to said image-sensing component through said camera lens.

2. The digital data presenting apparatus of claim 1 being a digital data visualizer mounted on the ceiling.

3. The digital data presenting apparatus of claim 1, wherein said image-sensing component is one of a charge coupled device (CCD) or a complementary metal oxide semiconductor (CMOS) image sensor.

4. The digital data presenting apparatus of claim 1, wherein said lens assembly has an adjustable focal distance.

5. The digital data presenting apparatus of claim 1, wherein said first deflector is a reflector controlling a reflection angle of said light by means of an adjustment device for altering a reflection direction of said light.

6. The digital data presenting apparatus of claim 1, wherein said lighting system further comprises:
a light-emitting component emitting a light;
a light tunnel component collecting said light emitted from said light-emitting component;
a frame determining a shape of said projection area of said light guided to said lens assembly; and
a second deflector guiding said light to said object to be displayed.

7. The digital data presenting apparatus of claim 6, wherein said light-emitting component is a halogen bulb.

8. The digital data presenting apparatus of claim 7, wherein said halogen bulb has a reflector.

9. The digital data presenting apparatus of claim 6, wherein said second deflector is a reflector controlling a reflection angle of said light by means of an adjustment device for altering a reflection direction of said light.

10. The digital data presenting apparatus of claim 9, wherein said adjustment device is a screw.

11. A digital data presenting apparatus, comprising:
a lighting system having a light-emitting component providing a light, comprising:
a lens assembly controlling said light to a projection area of an object to be displayed; and
a deflector for guiding said light to said object; and
a camera system having an image-sensing component, a camera lens positioned on one side of said image-sensing component and a second deflector for adjusting a propagation direction of said light reflected from said object to said image-sensing component through said camera lens.

12. The digital data presenting apparatus of claim 11, wherein said image-sensing component is one of a charged coupled device (CCD) or a CMOS image sensor.

13. The digital data presenting apparatus of claim 11, wherein said second deflector are reflector controlling a reflection angle of said light by means of an adjustment device for altering a reflection direction of said light.

14. The digital data presenting apparatus of claim 11, wherein said lens assembly has an adjustable focal distance.

15. The digital data presenting apparatus of claim 11, wherein said light-emitting component is a halogen bulb.

16. The digital data presenting apparatus of claim 11, wherein said halogen bulb has a reflector.

17. The digital data presenting apparatus of claim 11, wherein said a frame is used to control the lighting shape.

18. The digital data presenting apparatus of claim 11, wherein said lighting system further comprises a light tunnel component.

19. A digital data presenting apparatus, comprising:
a lighting system emitting a light comprising:
a light-emitting component;
a lens assembly controlling said light onto a projection area of an object;
a light tunnel component collecting said light emitted from said light-emitting component; and
a camera system comprising an image-sensing component and a camera lens positioned on one side of said image-sensing component.

20. The digital data presenting apparatus of claim 19, wherein said lighting system further comprises a frame determining a shape of said projection area of said light guided to said lens assembly.

21. The digital data presenting apparatus of claim 19, wherein said lighting system further comprises a first deflector guiding said light to said object to be displayed.

22. The digital data presenting apparatus of claim 19, wherein said camera system further comprises a second deflector adjusting a propagation direction of said light reflected from said object to be displayed to said image-sensing component through said camera lens.
